(19) United States
(12) Patent Application Publication
(10) Pub. No.: US 2011/0245455 A1
(43) Pub. Date: Oct. 6, 2011

(54) POLYIMIDE FILM

(75) Inventors: Young Han JEONG, Suseong-gu (KR); Hyo Jun Park, Yongin-si (KR); Hak Gee Jung, Yongin-si (KR)

(73) Assignee: KOLON INDUSTRIES, INC., Gwacheon-si (KR)

(21) Appl. No.: 13/075,849

(22) Filed: Mar. 30, 2011

(30) Foreign Application Priority Data
Mar. 30, 2010 (KR) 10-2010-0028359

(51) Int. Cl. C08G 73/10

(52) U.S. Cl. 528/353

(57) ABSTRACT

The present invention provides a polyimide film having a good transparency and also an excellent thermal resistance so that it is useful in a transparent conductive film, TFT substrate, a flexible printing circuit substrate, and the like.

### TECHNICAL FIELD

The present invention relates to a colorless and transparent polyimide film having an excellent thermal resistance.

### BACKGROUND ART

Polyimide resin is insoluble and infusible resin having a super high thermal resistance, and has excellent properties, such as a thermally-oxidation resistance, a thermal resistance property, a radiation resistance, a low temperature property, a chemical resistance, and the like. Therefore, the polyimide resin is being used in wide fields, such as thermal resistance state-of-the-art materials, for example materials for automobile, materials for flight, materials for spacecraft, and the like, and electronic materials, for example an insulation coating, an insulation film, a semiconductor, an electrode protective film of TFT-LCD, and the like, and also is being recently used in a transparent electrode film, and the like by coating on a surface or containing a conductive filler in a film and display material, such as an optical fiber or a liquid crystal alignment film.

However, a general polyimide resin has turned brown or yellow due to high density of aromatic ring so that it has low transmittance in a visible ray region and has a color that is associated with yellow so that makes optical transmittance to be decreased. Therefore, the general polyimide resin is difficult to use in the field that needs transparency.

Therefore, various efforts are being performed in order to improve a color and transmittance of a general polyimide film, but the thermal resistance seems to be decreased in proportion to the improvement of the color and the transmittance of the film.

In addition, the supply of a transparent film having high thermal resistance is required in addition to a diversification of the function in the use for various electric•electronic materials that are applied with the polyimide film.

### DISCLOSURE

### Technical Problem

The present invention is to provide a polyimide film having a satisfactory thermal resistance and also a satisfactory transparent.

An embodiment according to the present invention provides the polyimide film is obtained by casting the imide of the polyamic acid obtained from the polymerization of diamine and acid dianhydride, and has the polyimide content of not more than 70% based on the film weight, in which its absolute molecular weight is not more than 10×10⁴ g/mol as determined from the following Equation 1.

Preferably, the polyimide content may be not less than 0.03% based on the film weight in terms of processability, in which the absolute molecular weight of the polyimide is not more than 10×10⁴ g/mol.

$$\frac{{R}_{θ}}{{K}^{*} c} = MP ( θ ) - 2 {A}_{2} {cM}^{2} {P}^{2} ( θ ) \qquad [ Equation 1 ]$$

The above Equation 1 is drawn from a principle of the decision of molar mass and size of polymer from angular variation and the amount of scattered light that are evaluated by irradiating laser light to the solution containing solvent and any polymer, through using the principle, in which charge transfer quantities and radiant quantities of light are depended on a polarizability of material for the phenomenon, in which the material causes a polarization of charge according to the interaction with light, and for this reason, vibration charges make light to be spread in all directions;

R_{θ} is the excess Rayleigh ratio;

K*=4π²n₀²(dn/dc)²λ₀⁻⁴N_{A}⁻¹, in which n₀ is an refractive index of solvent, N_{A} is Avogadro's number, and dn/dc is a specific refractive index increment, which is the value that the value of the change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer;

c is a polymer concentration (g/ml) in a solution;

M is a weight average molecular weight (Mw) in the case of the poly disperse sample as a molar mass;

A₂ is the second virial coefficient; and

P(θ)=R_{θ}/R₀.

Also, the absolute molecular weight (Mw) of the polyimide film according to an embodiment of the present invention may be 30,000 to 170,000 g/mol, in which the absolute molecular weight is determined from the following Equation 1.

$$\frac{{R}_{θ}}{{K}^{*} c} = MP ( θ ) - 2 {A}_{2} {cM}^{2} {P}^{2} ( θ ) \qquad [ Equation 1 ]$$

The above Equation 1 is drawn from a principle of the decision of molar mass and size of polymer from angular variation and the amount of scattered light that are evaluated by irradiating laser light to the solution containing solvent and any polymer, through using the principle, in which charge transfer quantities and radiant quantities of light are depended on a polarizability of material for the phenomenon, in which the material causes a polarization of charge according to the interaction with light, and for this reason, vibration charges make light to be spread in all directions;

R_{θ} is the excess Rayleigh ratio;

K*=4π²n₀²(dn/dc)²λ₀⁻⁴N_{A}⁻¹, in which n₀ is an refractive index of solvent, N_{A} is Avogadro's number, and dn/dc is a specific refractive index increment, which is that a change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer;

c is a polymer concentration (g/ml) in a solution;

M is a weight average molecular weight (Mw) in the case of the poly disperse sample as a molar mass;

A₂ is the second virial coefficient; and

P(θ)=R_{θ}/R₀.

Also, the specific refractive index increment (dn/dc) of the polyimide film according to an embodiment of the present invention may be 0.100 to 0.1800, in which the specific refractive index increment (dn/dc) is defined as follows.

Specific Refractive Index Increment (dn/dc): the value is that a change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer.

More preferably, the specific refractive index increment (dn/dc) may be 0.100 to 0.1300.

For the polyimide film according to an embodiment of the present invention, the acid dianhydride may include 2,2-bis(3,4-dicarboxyphenyl)hexafluoropropane dianhydride, and preferably 2,2-bis(3,4-dicarboxylphenyl)hexafluoropropane dianhydride may be included in 30 mole % to 100 mole % in the acid dianhydride.

For the polyimide film according to an embodiment of the present invention, the diamine may include 2,2′-bis(trifluoromethyl)-4,4′-diaminobiphenyl, and preferably 2,2′-bis(trifluoromethyl)-4,4′-diaminobiphenyl may be included in 20 mole % to 100 mole % in the diamine.

For the polyimide film according to an embodiment of the present invention, a yellowness may be less than 3.5 based on the film thickness of 50˜100 μm.

In addition, for the polyimide film according to an embodiment of the present invention, a mean coefficient of linear thermal expansion (CTE) may be less than 70 ppm/° C., in which the mean coefficient of linear thermal expansion (CTE) is measured within the range of 50 to 250° C. using a thermomechanical analysis based on the film thickness of 50˜100 μm.

The polyimide film according to an embodiment of the present invention has a good transparency and also an excellent thermal resistance thereby decreasing the dimensional changes according to the thermal stress so that it expected to be useful in a transparent conductive film, TFT substrate, a flexible printing circuit substrate, and the like.

### DESCRIPTION OF DRAWINGS

The above and other objects, features and advantages of the present invention will become apparent from the following description of preferred embodiments given in conjunction with the accompanying drawings, in which:

FIG. 1 is a graph showing a differential weight fraction measured about the film obtained from Example 1 according to the present invention; and

FIG. 2 is a cumulative weight fraction graph obtained from a differential weight fraction.

### BEST MODE

Hereinafter, the present invention will be described in more detail as follows.

The polyimide film according to an embodiment of the present invention is obtained by casting the imide of the polyamic acid obtained from the polymerization of diamine and acid dianhydride in terms of securing a transparency and satisfactory thermal resistance, and has the polyimide content of not more than 70% based on the film weight, in which its absolute molecular weight is not more than 10×10⁴ g/mol as determined from the following Equation 1.

$$\frac{{R}_{θ}}{{K}^{*} c} = MP ( θ ) - 2 {A}_{2} {cM}^{2} {P}^{2} ( θ ) \qquad [ Equation 1 ]$$

The above Equation 1 is drawn from a principle of the decision of molar mass and size of polymer from angular variation and the amount of scattered light that are evaluated by irradiating laser light to the solution containing solvent and any polymer, through using the principle, in which charge transfer quantities and radiant quantities of light are depended on a polarizability of material for the phenomenon, in which the material causes a polarization of charge according to the interaction with light, and for this reason, vibration charges make light to be spread in all directions;

R_{θ} is the excess Rayleigh ratio;

K*=4π²n₀²(dn/dc)²λ₀⁻⁴N_{A}⁻¹, in which n₀ is an refractive index of solvent, N_{A} is Avogadro's number, and dn/dc is a specific refractive index increment, which is the value that the value of the change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer;

c is a polymer concentration (g/ml) in a solution;

M is a weight average molecular weight (Mw) in the case of the poly disperse sample as a molar mass;

A₂ is the second virial coefficient; and

P(θ)=R_{θ}/R₀.

Example of a method for measuring the absolute molecular weight for the measurement of the molecular weight of polymer may include a method for measuring the absolute molecular weight using a light scattering in a polymer solution.

The light scattering is occurred through a polymer chain in the polymer solution because the size of polymer coil is smaller than the wavelength of light or similar to the wavelength of light and also the polymer chain is polarized by an electric field of incident light. The degree of scattering is not proportional to the amount of material that generates the scattering and the scattering due to larger particles is too strong as compared to the scattering due to smaller particles when the scatterer is present in a same amount. Therefore, the scattering degree of light is affected by the size of particle so that the information about the molecular weight of polymer can be obtained when using the scattering degree of light. In addition, when light is passed through the dilute polymer solution, of which the refractive index of solvent is different from the refractive index of polymer that is dissolved in the solvent, light will be scattered according to the strength that is depended to the size and concentration of polymer that is dissolved in addition to the difference between the refractive indexes of the polymer and the solvent. If the polymer solution is the sufficient dilute solution, the strength of scattered light will be indicated in the total level of contribution for scattering that is generated by each polymer coil that is well separated in a solution. The reason is that the strength of light that is scattered by each polymer coil in any direction is proportional to a square of vector size of light wave that is scattered when the size of the dissolved polymer coils is isotropy if it is very smaller than the wavelength of light or same polarity in all the directions.

The absolute molecular weight for the present invention may be measured from the above principle, and also the calculation of polyimide fraction ratio having the specific absolute molecular weight may be possible to use the above principle.

The molecular weight profile of the polyimide film may be obtained from a gel permeation chromatography.

The value of “differential weight fraction,” which is represented as % is a percentage frequency of mole mass fraction, and specifically, the molecular weight fraction ratio of polyimide composing film can be measured by using a detector of the above principle.

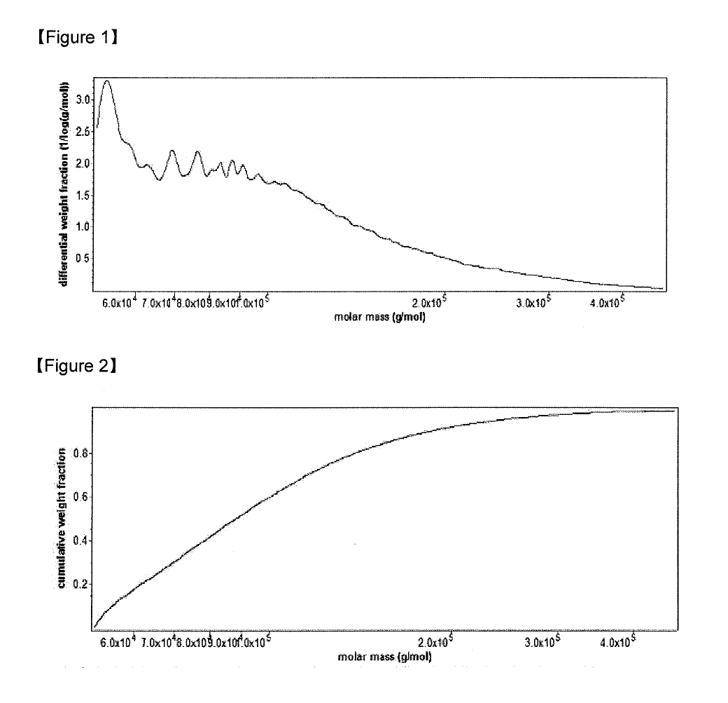

For example, FIG. 1 is a graph showing a differential weight fraction detected about the film obtained from an embodiment according to the present invention, and when converting it to the cumulative weight fraction data, the cumulative graph can be obtained as FIG. 2.

From the cumulative graph of FIG. 2, it can be confirmed that total fraction ratio of molecular weight having not more than 10×10⁴ g/mol of the absolute molecular weight is about 60.1%.

When the fraction ratio of molecular weight that has the absolute molecular weight of not more than 10×10⁴ g/mol is not more than 70.0% for the molecular weight of polyimide composing the polyimide film obtained from the above principle, the thermal resistance or transmission may be satisfied, and also the yellowness may be excellent.

If the fraction ratio of molecular weight that has the absolute molecular weight of not more than 10×10⁴ g/mol is above 70.0% for the molecular weight of polyimide composing the polyimide film, it does not largely affect the transmission, but it makes the yellowness to be increased.

If the fraction ratio of molecular weight that has the absolute molecular weight of not more than 10×10⁴ g/mol is below 70.0% for the molecular weight of polyimide composing the polyimide film, the yellowness may be gradually improved while the transparency and the thermal property may be not significantly changed.

However, in the case of excessively increasing the fraction ratio of molecular weight having the absolute molecular weight of not more than 10×10⁴ g/mol, the casting property may be damaged so that preferably, the fraction ratio of molecular weight having the absolute molecular weight of not more than 10×10⁴ g/mol may be preferably at least 0.03%. That is, in the case of excessively increasing the fraction ratio of molecular weight having the absolute molecular weight of not more than 10×10⁴ g/mol, there are many long polymer chains in general so that the viscosity is increased thereby damaging the casting process. Therefore, the fraction ratio of molecular weight having the absolute molecular weight of not more than 10×10⁴ g/mol may be preferably at least 0.03%.

Meanwhile, for calculating the information about the molecular weight by the above light scattering, a constant of the refractive index value according to the concentration of each polymer should be firstly determined; and the constant of the refractive index value according to the concentration is the value involved in the mole ratio of monomers composing the acid dianhydride that is used for polymerizing a polyimide precursor, and is relevant to the intrinsic value of the material.

However, for the polyimide powder or the polyimide film, the preparation of the sample according to the concentration is generally difficult by dissolving the sample in an organic solvent, and also the measurement of the refractive index is difficult because the polymer solution is not easily prepared due to many aromatic rings. When many aromatic rings are presented, the colored polymer is appeared.

In this sense, the polyimide film having the specific refractive index increment (dn/dc) of 0.100 to 0.1800 that is provided according an embodiment of the present invention has good transparency and thermal resistance. More preferably, it may be preferably the polyimide film having the specific refractive index increment (dn/dc) of 0.100 to 0.1300 in terms of the transparency and thermal resistance.

Meanwhile, the absolute molecular weight of the polyimide film according to an embodiment of the present invention may be 30,000 to 170,000 g/mol, in which the absolute molecular weight is determined from the following Equation 1.

$$\frac{{R}_{θ}}{{K}^{*} c} = MP ( θ ) - 2 {A}_{2} {cM}^{2} {P}^{2} ( θ ) \qquad [ Equation 1 ]$$

The above Equation 1 is drawn from a principle of the decision of molar mass and size of polymer from angular variation and the amount of scattered light that are evaluated by irradiating laser light to the solution containing solvent and any polymer, through using the principle, in which charge transfer quantities and radiant quantities of light are depended on a polarizability of material for the phenomenon, in which the material causes a polarization of charge according to the interaction with light, and for this reason, vibration charges make light to be spread in all directions;

R_{θ} is the excess Rayleigh ratio;

K*=4π²n₀²(dn/dc)²λ₀⁻⁴N_{A}⁻¹, in which n₀ is an refractive index of solvent, N_{A} is Avogadro's number, and dn/dc is a specific refractive index increment, which is the value that the value of the change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer;

c is a polymer concentration (g/ml) in a solution;

M is a weight average molecular weight (Mw) in the case of the poly disperse sample as a molar mass;

A₂ is the second virial coefficient; and

P(θ)=R_{θ}/R₀.

As mentioned above, in the case of the polyimide film, the measurement of the absolute molecular weight value according to the light scattering is generally difficult because the polymer solution may be not easily prepared due to many aromatic rings. When many aromatic rings are presented, the colored polyimide film is appeared.

In this sense, the polyimide film having the absolute molecular weight (Mw) of 30,000 to 170,000 g/mol obtained from MALS that is provided according an embodiment of the present invention has good transparency and thermal to resistance.

Example of obtaining the values, such as the differential weight fraction, the specific refractive index increment (dn/dc) and the absolute molecular weight as mentioned above is MALS (Multi Angle Light Scattering) system from Wyatt Company. The weight average molecular weight, the size, the molecular weight distribution, and other many data of the sample to be analyzed can be obtained through the above MALS system.

Examples of a method for obtaining the polyimide film that is satisfied with the differential weight fraction ratio of the absolute molecular weight as mentioned above may be depended on the selection of monomer, the control of the monomer content, the polymerization order, a method for polymerizing, and the like, and also may be depended on a precipitation method for obtaining the polyimide powder.

For example, the polyimide film according to an embodiment of the present invention may be obtained from the process comprising: firstly obtaining the polyamic acid by the polymerization of the acid dianhydride and the diamine; preparing the powder by imidizing the polyamic acid; and then casting the imidized powder.

Considering the transparency, the acid dianhydride preferably includes 2,2-bis(3,4-dicarboxyphenyl)hexafluoropropane dianhydride (6-FDA). And also, one or more one selected from the group consisting of 4-(2,5-dioxotetrahydrofuran-3-yl)-1,2,3,4-tetrahydronaphtalene-1,2-dicarboxlic anhydride (TDA) and 4,4′-(4,4′-isopropylidenediphenoxy)bis(phthalic anhydride) (HBDA) may further be included. Considering the thermal resistance, more preferably, one or more one selected from the group consisting of pyromellitic dianhydride (PMDA), biphenyltetracarboxylic dianhydride (BPDA) and oxydiphthalic dianhydride (ODPA) may be used jointly.

The use amount of 6-FDA in the acid dianhydride may be preferably 30 to 100 mol % in terms of the expression of the transparency while not inhibiting other properties, for example, the thermal resistance, and the like.

Meanwhile, examples of the diamine may include one or more one selected from the group consisting of 2,2-bis[4-(4-aminophenoxy)-phenyl]propane (6HMDA), 2,2′-bis(trifluoromethyl)-4,4′-diaminobiphenyl (2,2′-TFDB), 3,3′-bis(trifluoromethyl)-4,4′-diaminophenyl (3,3′-TFDB), 4,4′-bis(3-aminophenoxy)diphenylsulfone (DBSDA), bis(3-aminophenyl)sulfone (3DDS), bis(4-aminophenyl)sulfone (4DDS), 1,3-bis(3-aminophenoxy)benzene (APB-133), 1,4-bis(4-aminophenoxy)benzene (APB-134), 2,2′-bis[3(3-aminophenoxy)phenyl]hexafluoropropane (3-BDAF), 2,2′-bis[4(4-aminophenoxy)phenyl]hexafluoropropane (4-BDAF), 2,2′-bis(3-aminophenyl)hexafluoropropane (3,3′-6F), 2,2′-bis(4-aminophenyl)hexafluoropropane (4,4′-6F) and oxydianiline (ODA), and 2,2′-TFDB in the diamines may be preferably included in terms of the proper free volume secured by the side chain.

More preferably, 2,2′-TFDB in total diamines may be included in 20 to 100 mol % in terms of the maintenance of the transparency through the free volume secured by the side chain.

The solution of the polyamic acid is prepared by dissolving and reacting in a solvent to be the equimolar amount of the above acid dianhydride component and the diamine component.

The reaction conditions are not limited specifically, but the temperature of the reaction is preferably −20˜80° C.; and the time for polymerizing is 1 to 24 hours and preferably 8 to 12 hours. In addition, an inert atmosphere, such as argon, nitrogen, and the like is more preferable when reacting.

Examples of the solvent (hereinafter, called as a first solvent) for the solution polymerization of the above monomers are not limited specifically if a solvent is possible to dissolve the polyamic acid. One or more polar solvent selected from the group consisting of m-cresol, n-methyl-2-pyrrolidone (NMP), dimethylformamide (DMF), dimethylacetamide (DMAc), dimethylsulfoxide (DMSO), acetone, diethylacetate is used as the known reaction solvent. Above this, a low boiling point solution, such as tetrahydrofuran (THF) and chloroform, and a low absorbency solvent, such as γ-butyrolactone may be used.

The content of the first solvent is not limited specifically, but the content of the first solvent is preferably 50˜95 wt %, and more preferably 70˜90 wt % in total solution of the polyamic acid in order to obtain the proper molecular weight and the proper viscosity of the polyamic acid solution.

A method for preparing the polyimide powder by using the above monomers is not limited specifically, but examples thereof may include a method for obtaining the solid of the polyimide resin, including obtaining the solution of the polyamic acid by polymerizing the diamine and the acid dianhydride under the first solvent; preparing the solution containing the imide by imidizing the solution of the polyamic acid obtained from the above step; precipitating by adding a second solvent to the solution containing the imide; and filtering and drying the solid precipitated in the above step.

At this time, the polarity of the second solvent may be lower than that of the first solvent because it is the solvent for precipitating the resin solid.

Examples thereof may include water, methyl alcohol, ethyl alcohol, isopropyl alcohol, ethylene glycol, triethylene glycol, 2-butyl alcohol, 2-propyl alcohol, 2-hexyl alcohol, cyclopentyl alcohol, cyclohexyl alcohol, phenol, t-butyl alcohol, and the like.

Meanwhile, the thermal resistance of the polyimide can be ultimately controlled by controlling the injection order of monomers, and for example, it may to be preferable that 6-FDA in the acid dianhydride is finally injected for polymerizing so that the molecular weight can be increased the polyimide powder having more higher absolute molecular weight can be obtained for the same time of the polymerization as compared to the case of firstly injecting. Consequently, the thermal resistance of film can be controlled by controlling the injection order of monomers so that the thermal resistance can be more improved in the case of the polyimide powder having large absolute molecular weight.

In addition, the thermal resistance of film can be controlled according to the time of the polymerization so that if the time of the polymerization is increased, the value of the absolute molecular weight can be increased. However, over certain time of the polymerization, the value of the absolute molecular weight is again decreased so that when the time of the polymerization is excessively long, the absolute molecular weight will be decreased due to a depolymerization.

Therefore, when the time of the polymerization is excessively long, the thermal stability (CTE) may be deteriorated due to the decrease of the molecular weight, while when the time of the polymerization is excessively short, the distribution of the molecular weight (PDI) is excessively becoming wider so that the mechanical material property of film can be deteriorated. Therefore, the time of the polymerization may be preferably 1 to 24 hours, and more preferably 8 to 12 hours thereby having the proper absolute molecular weight value and the absolute to molecular weight distribution so that the polyimide powder that is evenly satisfied with the thermal resistance and the transparency can be obtained.

When imidizing through injecting the chemical converting agent to the solution of the polyamic acid, the degree of the imidization may be not less than 80%, and preferably not less than 85% in terms of optical and mechanical property, and thermal resistance.

For the condition for drying after filtering the solid of polyimide resin obtained, preferably the temperature is 50˜120° C. and the time is 3˜24 hours considering the boiling point of the second solvent.

The method for preparing the polyimide film may include preparing the solution of the polyimide by dissolving the polyimide powder obtained from the above method in an organic solvent, casting thereof, and then heating.

At this time, the first solvent may be used as the organic solvent.

The polyimide film may be obtained by casting the solution of the polyimide on the support, and heating for 1 minute˜8 hours while gradually increasing the temperature within the range of 40˜400° C., and then the heating may be further performed in terms of the increase of the thermal stability and the decrease of the thermal history. The temperature of the further heating is preferably 100˜500° C. and the time of the heating is preferably 1 minute˜30 minutes.

The remained volatile component of film that is completely heated may be not more than 5%, and preferably not more than 3%.

At this time, the chemical converting agent may be a dehydrating agent that is represented by the acid anhydride, such as acetic anhydride, and the like, and an imidization catalyst that is represented by tertiary amine, such as isoquinoline, β-picoline, pyridine, and the like, and the chemical imidization may be preferably used jointly in terms of the decrease of the molecular weight decline.

In addition, the polyimide film according to an embodiment of the present invention may preferably has a degree of yellowness of not more than 3.5 based on the film thickness of 50˜100 μm in terms of the securing of the transparency.

In addition, the mean transmittance that is measured at 400 to 740 nm using UV spectrophotometer based on the film thickness of 50˜100 μm is preferably not less than 85%. If the mean transmittance that is measured at 400 to 740 nm using UV spectrophotometer based on the film thickness of 50˜100 μm is less than 85%, there may be a problem such that the proper visual effect cannot be displayed for using as a usage of display.

In addition, considering the effect on the dimensional change, the mean coefficient of linear thermal expansion (CTE) of the polyimide film is preferable not more than 70 ppm/° C., in which the mean coefficient of linear thermal expansion (CTE) is measured within the range of 50 to 250° C. using the thermomechanical analysis based on the film thickness of 50˜100 μm. If the coefficient of linear thermal expansion is larger than the above value, it may lead to the dimensional change because the coefficient of linear thermal expansion is excessively becoming large and the difference with the coefficient of linear thermal expansion of a metal foil is becoming large when preparing an adhesive film.

Preferably, the mean coefficient of linear thermal expansion (CTE) may be 15 ppm/° C. to 60 ppm/° C.

### BEST MODE

Hereinafter, the embodiments of the present invention will be described in detail as follows, but the present invention will not be limited thereto.

### Example 1

While a nitrogen was passing through 1 L reactor comprising a stirrer, a nitrogen injector, a dropping funnel, a thermostat and a cooler as a reactor, 605.6 g of N,N-dimethylacetamide (DMAc) was filled into the reactor, and then the temperature of the reactor was adjusted at 25° C. And then, 64.046 g (0.2 mol) of TFDB was dissolved and maintained at 25° C. To the reactor, 11.7680 g (0.04 mol) of BPDA was added and stirred for 1 hour to completely dissolve BPDA. At this time, the temperature of the solution was maintained at 25° C. And, 71.08 g (0.16 mol) of 6FDA was added and then the solution of the polyamic acid having the solid concentration of 20 wt % was obtained.

The solution of the polyamic acid was stirred at a room temperature for 12 hours; 31.64 g of pyridine and 40.91 g of acetic anhydride were injected and stirred for 30 minutes; and then it was stirred at 80° C. again for 1 hour to cool it to a room temperature; it was slowly injected to the container containing 20 L of methanol to precipitate; the precipitated solid was filtered and grinded; and then dried at 80° C. in vacuum for 6 hours to obtain 147 g of the solid powder (the degree of imidization was 80.5%).

The solid powder obtained from the above method was dissolved in 588 g of N,N-dimethylacetamide (DMAc) to obtain 20 wt % of the solution (viscosity: 70 poise).

After finishing the reaction, the obtained solution was applied to a stainless board and then cast in 700 μm; after drying for 1 hour with a hot-air of 150° C., the film was detached from the stainless board and then fixed in a frame with a pin.

After the frame fixed with the film was added to the vacuum oven and slowly heated for 2 hours from 100° C. to 300° C., it was slowly cooled to remove from the frame to obtain the polyimide film. And then, it was heated again for 30 minutes at 300° C. to obtain the polyimide film as the final heating (thickness: 100 μm, and the degree of imidization: 99.8%).

The data about the polymer was collected using the following method about the polyimide film obtained.

(1) Apparatus and Method for Analyzing

GPC & MALS Analysis Apparatus: GPC—Water 1525 Binary HPLC pump; RI detector—Wyatt optilab rEX; MALS—Wyatt Dawn 8+; Column—use by connecting with Shodex K-803, K-804 and K-805

(2) Pretreatment Method of Sample

0.05 g of the film obtained was weighed and added to 10 ml vial of DMF (containing 0.05% LiCl). The solution of DMF containing the film was added to an oven of 50° C. and dissolved for 2 hours while shaking. After completely dissolving the sample, it was filtered with 0.45 μm syringe filter and then installed to MALS autosampler.

(3) Analysis Method

Injection volume: 400 μl

Injection Temp.: 50° C.

Flow Rate: 1 ml/min

Eluent: DMF (containing 0.05% LiCl, Refractive index 1.390)

Column Temp.: 50° C.

Dn/Dc: see the following description

At this time, Dn/Dc relates to the specific refractive index increment, and is the value that a change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer. Specifically, the above value was measured as the following method.

(4) Analysis Apparatus that is used for Measuring Dn/Dc

RI Detector: Wyatt Optilavb rEX

(5) Pretreatment Method of Sample for Measuring Dn/Dc

Firstly, 0.2 g of the polyimide film obtained was dissolved in 50 ml of DMF (containing 0.05% LiCl) to prepare a sample of high concentration. At this time, because it was not easily dissolved, it was added to an oven of 50° C., and dissolved for about 2 hours while shaking. The samples having 0.0032 g/ml, 0.0024 g/ml, 0.0016 g/ml and 0.0008 g/ml concentration, respectively were prepared by diluting the sample having a high concentration. For each sample, the refractive index values according to the concentration were measured using 0.45 μm syringe filter.

(6) Analysis Method of Dn/Dc Sample

injection volume: 10 ml

injector Temp.: 50° C.

flow rate: 16 ml/hr

eluent: DMF (containing 0.05% LiCl, Refractive index 1.390)

As the results obtained from the above analysis, in the case of the polyimide film, Dn/Dc value was 0.1246±0.0012 at 50° C. of DMF (containing 0.05% LiCl).

The absolute molecular weight value and the differential weight fraction according to MALS can be calculated according to the above method from Dn/Dc value that was obtained. The results were shown in the following Table 1.

FIG. 1 was a graph showing the result of detecting the differential weight fraction about the film obtained according to Example 1, and when converting it to the cumulative weight fraction data, the cumulative graph can be obtained as FIG. 2.

From the above result, it could be confirmed that total fraction ratio of molecular weight having 10×10⁴ g/mol of the absolute molecular weight was about 60.1% for the obtained film according to Example 1.

Of course, the data that was the results of calculating the differential weight fraction for Examples was the results based on the above graph.

### Example 2 to Example 3

The same method with the above Example 1 was used for preparing the film, except changing mol % of BPDA to TFDB on preparing the solution of polyamic acid as the following Table 1.

Dn/Dc value, and the absolute molecular weight value and the differential weight fraction according to MALS can be calculated according to the same method with Example 1 for the obtained film. The results were shown in the following Table 1.

TABLE 1

| | | | Content of | |
|---|---|---|---|---|
| | | | Polyimide Having | |
| | | | Absolute | |
| | BPDA | | Molecular Weight | |
| | to | | of less than | |
| | TFDB | | 10 × 10⁴ g/mol | Mw |
| | (mol %) | Dn/Dc | (%) | (g/mol) |
| Example 1 | 20 | 0.1246 ± 0.0012 | 60.1 | 1.085 × 10⁵ |
| Example 2 | 40 | 0.1284 ± 0.0007 | 65.7 | 1.016 × 10⁵ |
| Example 3 | 50 | 0.1390 ± 0.0002 | 64.3 | 1.037 × 10⁵ |

For the films obtained from the above Example 1 to Example 3, the yellowness was measured according to ASTM E313, and then the results were shown in the following Table 2. In addition, the coefficient of linear thermal expansion (CTE) value was measured the range of 50 to 250° C. using a thermomechanical analysis, and then the result was shown in the following Table 2.

TABLE 2

| | CTE | | Mean Transmission |
|---|---|---|---|
| | (ppm/° C.) | Yellowness | (%) |
| Example 1 | 47.5 | 3.10 | 90.08 |
| Example 2 | 42.1 | 3.07 | 90.06 |
| Example 3 | 35.3 | 3.40 | 89.50 |

### Example 4 to Example 6 and Reference Example 1 to Reference Example 2

The same method with the above Example 1 was used for preparing the film, except controlling the time for stirring the polyamic acid as follows so that the film having the differential weight fraction ratio and the absolute molecular weight as the following Table 3 was prepared.

TABLE 3

| | | Time of | Content of Polyimide | |
|---|---|---|---|---|
| | | Stirring | Having Absolute | |
| | BPDA | Solution | Molecular Weight | |
| | to | of | of less than | |
| | TFDB | Polyamic | 10 × 10⁴ g/mol | Mw |
| | (mole %) | Acid (hr) | (%) | (g/mol) |
| Example 4 | 20 | 15 hr | 40.6 | 1.471 × 10⁵ |
| Example 5 | 20 | 18 hr | 15.4 | 1.711 × 10⁵ |
| Example 6 | 20 | 28 hr | 0.03 | 1.869 × 10⁵ |
| Re. Ex. 1 | 20 | 4 hr | 85.5 | 7.652 × 10⁴ |
| Re. Ex. 2 | 20 | 6 hr | 78.4 | 8.912 × 10⁴ |

For the films obtained from the above Example 4 to Example 6, and Reference Example 1 and Reference Example 2, the yellowness was measured according to ASTM E313, and then the results were shown in the following Table 4. In addition, the coefficient of linear thermal expansion (CTE) value was measured the range of 50 to 250° C. using a thermomechanical analysis, and then the result was shown in the following Table 4.

TABLE 4

| | CTE | | |
|---|---|---|---|
| | (ppm/° C.) | Yellowness | Mean Transmission |
| Example 4 | 47.3 | 2.97 | 88.1 |
| Example 5 | 47.4 | 2.95 | 88.1 |
| Example 6 | 47.3 | 2.96 | 88.2 |
| Reference Example 1 | 55.4 | 4.03 | 87.8 |
| Reference Example 2 | 51.8 | 3.75 | 87.8 |

From the results of the above Table 2 and Table 4, it could be known that when the content of the polyimide having the absolute molecular weight of not more than 10×10⁴ g/mol was not more than 70% based on total film weight, the yellowness was excellent, and also the thermal property and the light transmission to were excellent.

On the other hand, it could be known that when the content of the polyimide having the absolute molecular weight of not more than 10×10⁴ g/mol exceeds 70% based on total film weight, the yellowness was deteriorated even though the light transmission was not significantly decreased.

Meanwhile, it could be known that the yellowness was improved in proportion to the decrease of the content of the polyimide having the absolute molecular weight of not more than 10×10⁴ g/mol. However, because the content was decreased like Example 6 so that there were many long polymer chains in general, the viscosity would be increased and then may be disadvantaged on casting process. Therefore, it may be preferably required that the content of the polyimide having the absolute molecular weight of not more than 10×10⁴ g/mol is above 0.03%.

1. A polyimide film is obtained by casting an imide of a polyamic acid obtained from a polymerization of a diamine and an acid dianhydride, and has the polyimide content of not more than 70.0% based on the film weight, in which the absolute molecular weight of the polyimide is not more than 10×10⁴ g/mol as determined from the following Equation 1:
$$\frac{{R}_{θ}}{{K}^{*} c} = MP ( θ ) - 2 {A}_{2} {cM}^{2} {P}^{2} ( θ ) \qquad [ Equation 1 ]$$
[The above Equation 1 is drawn from a principle of the decision of molar mass and size of polymer from angular variation and the amount of scattered light that are evaluated by irradiating laser light to the solution containing solvent and any polymer, through using the principle, in which charge transfer quantities and radiant quantities of light are depended on a polarizability of material for the phenomenon, in which the material causes a polarization of charge according to the interaction with light, and for this reason, vibration charges make light to be spread in all directions;
R_{θ} is the excess Rayleigh ratio;
K*=4π²n₀²(dn/dc)²λ₀⁻⁴N_{A}⁻¹, in which n₀ is an refractive index of solvent, N_{A} is Avogadro's number, and dn/dc is a specific refractive index increment, which is the value that the value of the change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer;
c is a polymer concentration (g/ml) in a solution;
M is a weight average molecular weight (Mw) in the case of the poly disperse sample as a molar mass;
A₂ is the second virial coefficient; and
P(θ)=R_{θ}/R₀]

2. The polyimide film according to claim 1, wherein the content of the polyimide having the absolute molecular weight of not more than 10×10⁴ g/mol is not less than 0.03% based on the film weight.

3. The polyimide film according to claim 1, wherein the absolute molecular weight (Mw) that is determined according to the following Equation 1 is 30,000 to 170,000 g/mol:
$$\frac{{R}_{θ}}{{K}^{*} c} = MP ( θ ) - 2 {A}_{2} {cM}^{2} {P}^{2} ( θ ) \qquad [ Equation 1 ]$$
[The above Equation 1 is drawn from a principle of the decision of molar mass and size of polymer from angular variation and the amount of scattered light that are evaluated by irradiating laser light to the solution containing solvent and any polymer, through using the principle, in which charge transfer quantities and radiant quantities of light are depended on a polarizability of material for the phenomenon, in which the material causes a polarization of charge according to the interaction with light, and for this reason, vibration charges make light to be spread in all directions;
R_{θ} is the excess Rayleigh ratio;
K*=4π²n₀²(dn/dc)²λ₀⁻⁴N_{A}⁻¹, in which n₀ is an refractive index of solvent, N_{A} is Avogadro's number, and dn/dc is a specific refractive index increment, which is the value that the value of the change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer;
c is a polymer concentration (g/ml) in a solution;
M is a weight average molecular weight (Mw) in the case of the poly disperse sample as a molar mass;
A₂ is the second virial coefficient; and
P(θ)=R_{θ}/R₀]

4. The polyimide film according to claim 1, wherein the specific refractive index increment (dn/dc) that is defined as follows is 0.100 to 0.1800:
Specific refractive index increment (dn/dc): the value is that a change rate of refractive index according to the change rate of dilute solution concentration is differentiated and is measured within the range of 0.001 to 0.1 g/ml that is a section of concentration change when detecting a refractive index through injecting the polyimide film in a state of dilute solution in an organic solvent inside flow cell of differential refractometer.

5. The polyimide film according to claim 2, wherein the specific refractive index increment (dn/dc) is 0.100 to 0.1300.

6. The polyimide film according to claim 1, wherein the acid dianhydride includes 2,2-bis(3,4-dicarboxyphenyl)hexafluoropropane dianhydride.

7. The polyimide film according to claim 6, wherein 2,2-bis(3,4-dicarboxyphenyl)hexafluoropropane dianhydride is included in 30 mol % to 100 mol % in the acid dianhydride.

8. The polyimide film according to claim 1, wherein the diamine includes 2,2′-bis(trifluoromethyl)-4,4′-diaminobiphenyl.

9. The polyimide film according to claim 8, wherein 2,2′-bis(trifluoromethyl)-4,4′-diaminobiphenyl is included in 20 mol % to 100 mol % in the diamine.

10. The polyimide film according to claim 1, wherein a yellowness is not more than 3.5 based on the film thickness of 50˜100 μm.

11. The polyimide film according to claim 10, wherein a mean coefficient of linear thermal expansion (CTE) is not more than 70 ppm/° C., in which the mean coefficient of linear thermal expansion (CTE) is measured within the range of 50 to 250° C. using a thermomechanical analysis based on the film thickness of 50˜100 μm.
